(19) United States
(12) Patent Application Publication
(10) Pub. No.: US 2009/0210240 A1
(43) Pub. Date: Aug. 20, 2009

(54) SYSTEM AND METHOD OF AGE VERIFICATION FOR PURCHASING AGE-RESTRICTED ITEMS

(75) Inventors: Dirk Leonard Benschop, Etten-Leur (NL); Henderik Reinout Benschop, Rozenburg (NL); Sander Ewout Sciarone, Fijnaart (NL)

Correspondence Address: WESTMAN CHAMPLIN & KELLY, P.A., SUITE 1400, 900 SECOND AVENUE SOUTH, MINNEAPOLIS, MN, 55402, US

(73) Assignee: Hollandse Exploitatie Maatschappij B.V., Breda (NL)

(21) Appl. No.: 12/032,070

(22) Filed: Feb. 15, 2008

(51) Int. Cl. G06Q 99/00

(52) U.S. Cl. 705/1

(57) ABSTRACT

Aspects of the invention relate to an age verification terminal configured for verifying the age of a person and providing a purchase ticket for purchasing an age-restricted item is proposed. In one embodiment, the terminal comprises a video camera configured for capturing an image of the person and a document reader configured for capturing an image of an identification document of the person. The terminal also comprises a connecting device and receiving device. The connecting device configured for connecting to a remote age verification center to transmit the image of said person and the image of (at least a part of) the identification document to the age verification center. The receiver is configured for receiving a purchase approval signal from the age verification center in response to having transmitted the person image and/or the document image. The age verification module comprises a controller configured for controlling a ticket printer to print the purchase ticket in response to receiving the purchase approval signal. The purchase ticket then comprises an image of the person and/or a ticket code intended for allowing purchase of the age-restricted item.

### BACKGROUND

The discussion below is merely provided for general background information and is not intended to be used as an aid in determining the scope of the claimed subject matter.

Aspects of the invention relate to a system and method of age verification and to an age verification terminal. In particular, aspects of the invention relate to a system, method and terminal for age verification in relation to purchase of age-restricted items.

Nowadays, items as tobacco and alcoholic beverages receive increased attention as to their free availability for the under-aged. Instances of selling age-restricted goods to underage individuals also often result from careless employee verifications of a consumer's age before the consumer purchases age-restricted goods. Commonly, employees who are supposed to be verifying a consumer's age will not even ask for the consumer's identification, and in systems that prompt employees to enter the consumer's birth date, employees often enter a fictitious birth date. Such careless age verification may go unnoticed by a store manager or owner.

On the other hand, government authorities are increasingly willing to enforce fines and license suspension penalties on establishments that sell age-restricted goods to underage individuals. If authorities catch an employee selling age-restricted products to underage consumers, the manager or owner is often held responsible for the employee's actions and may even have their license to sell age-restricted goods revoked as a result of their employee's careless behaviour.

US 2002/087413 describes a vending machine including a video camera for transmitting an image of a buyer to a remotely located human operator, a document reader for transmitting an image of identification document(s) to the remotely located human in control of the vending machine, and a user interface which gives the appearance that the machine is autonomous even though the operator's approval is required prior to vending an age-restricted item. The machine also includes a payment acceptor and a dispensing apparatus.

However, age-restricted items may not be suitable for a vending machine for a variety of reasons and age verification for cash counter employees needs to be simplified.

There exists a need in the art to provide an improved method and system for controlling purchase of age-restricted items.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

An aspect of the invention is an age verification terminal configured for verifying the age of a person and providing a purchase “ticket”, i.e. authorization, for purchasing an age-restricted item. The terminal comprises one or more image capturing devices, such as but not limited to a video camera, document reader, scanner or the like, configured for capturing an image of the person and/or an image of an identification document of the person. The terminal also comprises a connecting device and a receiving device. The connecting device is configured for connecting and/or communicating to a remote age verification center to transmit the image of said person and/or the image of (at least a part of) the identification document to the age verification center. The receiving device or receiver is configured for receiving a purchase approval signal from the age verification center in response to the transmission of the person image and/or the document image. The age verification module can comprise a controller configured for controlling a ticket renderer to render (e.g. print or display) the purchase ticket in response to receiving the purchase approval signal. The purchase ticket then comprises the person image and/or a ticket code intended to allow purchase of said age-restricted item.

Another aspect of the invention is a computer-implemented method of verifying the age of a person and providing a purchase ticket for that person to purchase an age-restricted item. The method comprises capturing an image of the person and/or an image of an identification document of said person and transmitting the person image and/or document image to a remote age verification center. A purchase approval signal is then received from the age verification center and a purchase ticket is printed or rendered in response to the purchase approval signal. The purchase ticket can comprise the person image and/or a ticket code intended to allow purchase of said age-restricted item.

It should be appreciated that the image capture device, e.g. a video camera and/or a document reader may be a single device, possibly with different settings adapted to the image to be made. It should also be appreciated that the controller of the terminal device may be a limited function device allowing an external controller, e.g. a controller of the age verification center, to issue the command to the ticket printer to print the purchase ticket. This command may e.g. be received with the purchase approval signal.

It should also be appreciated that the image of the identification document may preferably contain an image of the legitimate holder of the identification document. The image of the identification document may comprise a complete image of (one or more pages of) the identification document, a part of the identification document and/or information derived from the identification document.

The applicant also proposes an age verification center, a system comprising the age verification terminal and the age verification center and a purchase ticket.

The purchase ticket with the person image and/or the ticket code allowing purchase of the age-restricted item provides for an additional instrument by which the purchase of age-restricted goods can be controlled without being limited to storing these goods in vending machines and by relieving cash counter personal from verifying the age of a person. The purchase ticket can be used at a cash desk for payment or completion of a transaction of the age-restricted good(s). The cash desk personal has no involvement in the age verification process as such and should only control the result of the verification by using the purchase ticket, possibly in combination with the cash desk system. In one embodiment, the purchase ticket comprises at least the person image in order to have a direct link between the purchase ticket and the verified person.

The age verification process can comprise two separate process phases.

In a first phase, an image is captured of the person by a image capturing device. This image sent to an age verification center within a very short time interval, possibly seconds. This process phase involves only a low burden and is convenient for the person involved. If it can be determined that the age of the person is appropriate for purchasing the age-restricted item(s), the purchase approval signal is received and the purchase ticket can be printed immediately, for example, in accordance with the embodiment of claim 10. The potential purchaser may then bring the purchase ticket and the age restricted item to the cash desk and pay for the item using the purchase ticket.

If desired, such as if the age cannot be determined accurately by using the image capturing device, (and in one embodiment, only if the age cannot be determined accurately by using the image capturing device), a second process phase may be required. This second phase involves the reading of an identification document of the person whose age could not be verified in the first phase. The image of the identification document should comprise a picture of the legitimate holder of the document. This process phase is typically more time-consuming than the first process phase. The image of the identification document, or a sample thereof, is sent to the age verification center. Moreover, the person image is obtained again, either from a database (or other means of storage or from a second image by the image capture device in order to verify if the person image and document image are associated with the same person. If this is true and it can be determined that age of the person in question is appropriate for purchasing the age-restricted item, the purchase approval signal is received and the purchase ticket can be printed immediately, for example, in accordance with the embodiment of claim 11. The potential purchaser may then bring the purchase ticket and the age restricted item to the cash desk and pay for the item using the purchase ticket.

Other aspects of the invention are provided below, but should not be considered required or limiting.

The embodiments of claims 2 and 12 avoid that purchase tickets can be used at various places as a result of the point-of-purchase indication. It should be noted that the material of the ticket may also be pre-provisioned with a point-of-purchase indication. The indication may also serve to guarantee that the purchase ticket is genuine.

The embodiments of claims 3 and 13 allow for an indication for which item(s) the age verification has been performed. Items can be selected using selection mechanisms in accordance with the embodiments of claims 4 and 14.

The embodiments of claims 5 and 15 allow to display age verification information to purchasers. The display allows to inform potential purchasers that their image, and/or an image of an identification document may be required. This information may be mandatory to comply with privacy provisions in some areas. Furthermore, the display may guide potential purchasers through the age verification process. The display may be a touch screen comprising (soft) keys for entering instructions to the age verification terminal.

The embodiments of claims 6 and 16 provide for a quick recording of an image of the identification document.

The embodiments of claims 7 and 17 avoid that an image of a purchaser is recorded without his consent.

The embodiments of claims 8, 18 and 26 directly link the age verification process to the payment process at a cash desk for the purchased age-restricted item(s). The ticket code may e.g. be required to unlock the cash desk system to allow payment and/or to charge the item for the correct price.

In accordance with the embodiment of claim 20, the age verification is performed by a human on a display unit. The image of the person and, if necessary, the image of the identification document, are displayed on the display unit simultaneously. Although automized age verification is possible, age verification by a human being may provide the most accurate assessment of the age of a person.

The age verification center may be used for a plurality of age verification terminals in accordance with claim 21. Various embodiments of controlling the distribution of the images (load balancing) are provided in claims 22-25.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 provides a schematic illustration of a system in accordance with an embodiment of the invention;

FIGS. 2A and 2B provide a schematic illustration of an age verification terminal in accordance with an embodiment of the invention;

FIG. 3 provides a flow chart of a method of age verification in accordance with an embodiment of the invention;

FIG. 4 provides a communication time diagram of a method of age verification in accordance with an embodiment of the invention; and

FIGS. 5R and 5B show examples of purchase tickets in accordance with embodiments of the invention.

### DETAILED DESCRIPTION OF THE ILLUSTRATIVE EMBODIMENT

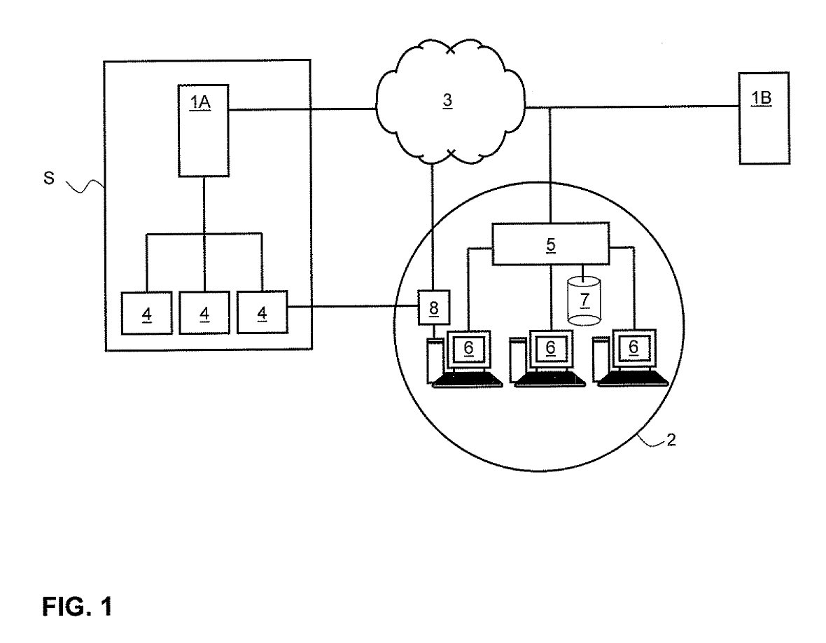

FIG. 1 shows a schematic illustration of a system comprising age verification terminals 1A, 1B and an age verification center 2 connected to the terminals 1A, 1B. Age verification terminal 1A is connected to the remote age verification center 2 via a network 3. The network 3 may comprise a wired network and/or a wireless, local and/or wide area (e.g. Internet) network.

Age verification terminal 1A is placed in, for example, a shop S, whereas age verification terminal 1B is placed at an arbitrary location and may possibly be shared by a number of shops or organizations. Age verification terminal 1A, 1B and age verification center 2 will hereinafter also be referred to as “terminal” and “verification center”, respectively.

In the illustrative embodiment, shop S sells a plurality of goods (items), amongst which are age-restricted items, such as tobacco, alcoholic beverages, adult magazines, weapons etc. Shop S comprises cash desk systems 4 for payment of items of the shop S. Cash desk systems 4 may be connected to the terminal 1A and/or the verification center 2.

The verification center 2 comprises a controller 5 and a plurality of display units 6. The display units 6 are configured to display images received from the terminals 1A, 1B to human beings in order to verify the age of potential purchasers of age-restricted items. The images include a person image of a potential purchaser and/or an image of (a part of) an identification document.

Controller 5 distributes the received images amongst the display units 6. The controller 5 may execute a round robin distribution process for efficient distribution of the images. In case more images are received than can be handled by the display units 6, the controller 5 is configured to manage a waiting cue of images. The controller 5 is also configured for providing, in the first verification phase, a person image of a potential purchaser to a first display unit 6 and, for the subsequent second verification phase, the person image and the document image on a second display unit 6, different from the first display unit.

The verification center 2 also comprises a database 7 and a ticket code allocator 8. The database 7 may store the received images and other data received from the terminals 1A, 1B for future use. The images can be retrieved from the database 7 when desired. Information from the database can be used for sales transaction information for shop owners and allows authorities to check the transactions regarding age-restricted items. Furthermore, the database information may be used for statistical analysis. The ticket code allocator 8 is connected to the cash desk system(s) 4 and is configured for providing a ticket code for the purchase ticket to be printed and to provide the code to the cash desk system(s) 4. The ticket code may be a unique or temporarily unique ticket code.

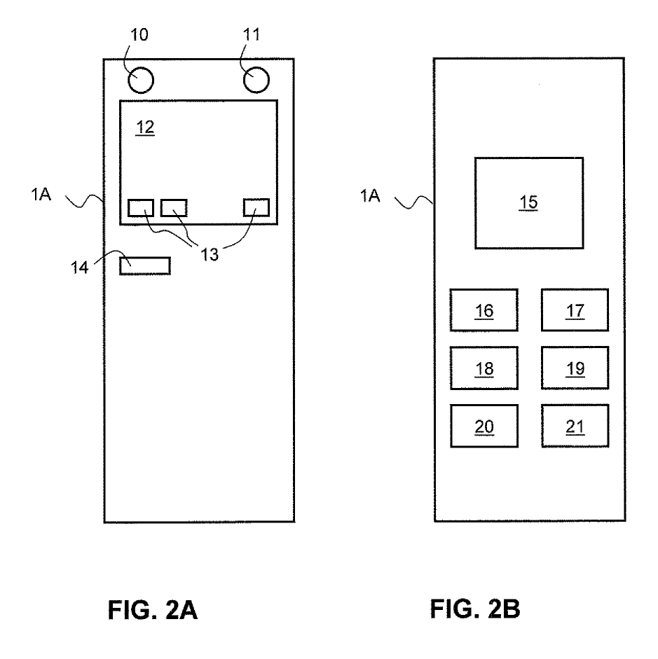

FIGS. 2A and 2B provide a schematic illustration of an age verification terminal 1A as shown in FIG. 1. The terminal 1 comprises an image capture device such as but not limited to a video camera 10 for capturing a live image of a person in front of the camera (a person image) and a document reader 11 (which also comprises a video camera in the present embodiment) configured for reading an identification document (a document image) of that person. Identification documents include, but are not limited to, passports, identity cards, drivers licenses etc. Preferably, the identification documents comprise a picture of the owner of the identification document in combination with information of the age of the owner. However, the documents may alternatively comprise information from which the age of the owner can be derived, e.g. at the age verification center 2. The age of the owner may e.g. be derived from information already stored in the database 7 or by making a connection to an external system from which the age of the owner of the identification document can be derived.

The terminal 1A further comprises a display 12. The display 12 may inform potential purchasers that their image, and/or an image of an identification document may be required before an item can be purchased. This information may be mandatory to comply with privacy provisions in some areas. Furthermore, the display 12 may guide potential purchasers through the age verification process. The user interface can take numerous forms, for instance, the display 12 may be a touch screen comprising (soft) keys 13 for entering instructions to the age verification terminal. The keys 13 may also be buttons with dedicated functions.

Terminal 1A can further comprise a ticket printer 14 for printing purchase tickets as will be explained in further detail hereinafter. Examples of such purchase tickets are shown in FIGS. 5A and 5B.

It should be appreciated that the image capturing device(s), e.g., the video camera 10 and the document reader 11 as well as the ticket printer 14 are not necessarily integral parts of the terminal 1A.

The terminal 1A comprises a controller 15 for controlling the ticket printer 14 and processing of other data. To that end, the controller 15 uses one or more of the following functional modules of the terminal 1A. It should be appreciated that the functions of the modules may be largely implemented as software code portions of one or more computer programs executed by the controller 15, which may be one or more ordinary computer processors in combination with one or more storage devices in a manner known as such to those of ordinary skill in the art.

It should be appreciated however, that the controller 15 may also be configured for receiving instructions and commands from the verification center 2, in particular the controller 5. As an example, controller 5 of verification center 2 may issue a command to print the purchase ticket via controller 15 to the ticket printer 14, and/or otherwise render the information to appropriate store personnel. The command may include the printing of the person image and/or the ticket code on the purchase ticket.

Terminal 1A comprises a connection module 16 configured for connecting to the remote age verification center 2 to transmit the person image and/or the document image to the verification center 2.

Terminal 1A also comprises a receiver module 17 configured for receiving a purchase approval signal from the remote age verification center 2 in response to the age verification at that center 2. The purchase approval signal may include a command to print or otherwise render the purchase ticket, or information thereof, at the site of the terminal 1A, or at another site, for example, at the cash desk to store personnel.

Terminal 1A can also comprises an item selection module 18 configured for selecting one or more items from a collection of age-restricted items in cooperation with the keys 13 provided on the display 12. It should be noted that such a selection module need not always be required, e.g. if all items are restricted to the same age. However, if the age-restriction differs for different items, such a selection module 18 is convenient.

In order to avoid unintended capturing of person images by video camera 10, the terminal 1A comprises a confirmation module 19 configured for instructing the video camera 10 to capture the person image.

Furthermore, the terminal 1A may have a ticket code allocator 20 for allocating a ticket code to a printed purchase ticket and a communication module 21 for communicating the allocated ticket code to the cash desk system 4. The ticket code may be a unique or temporarily unique ticket code.

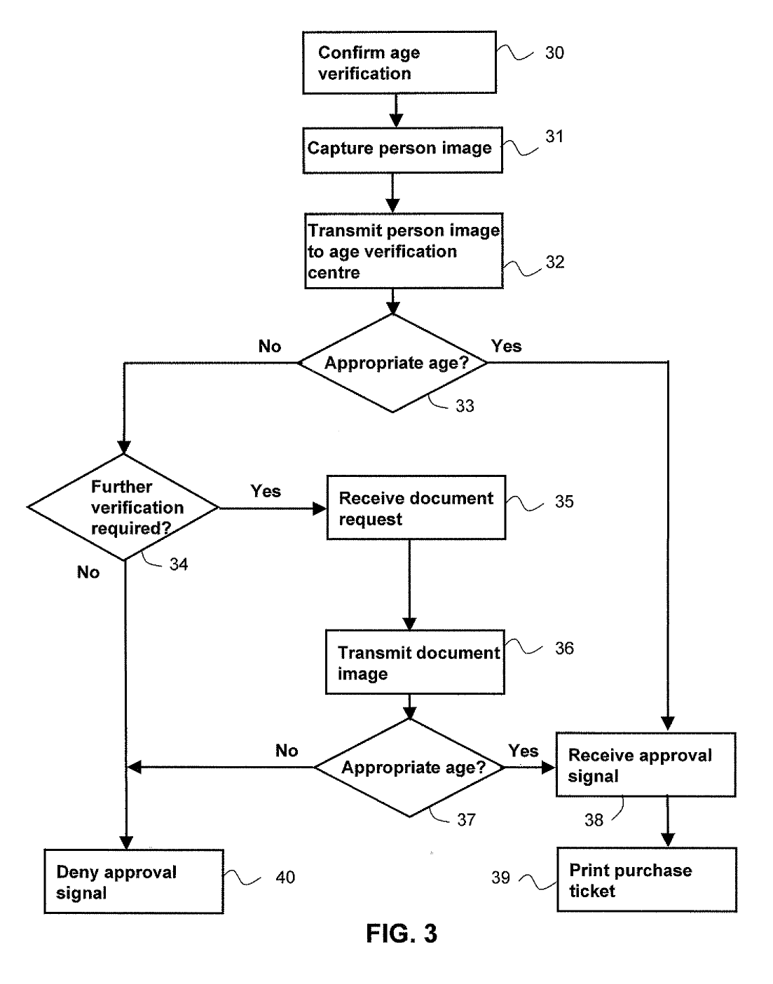

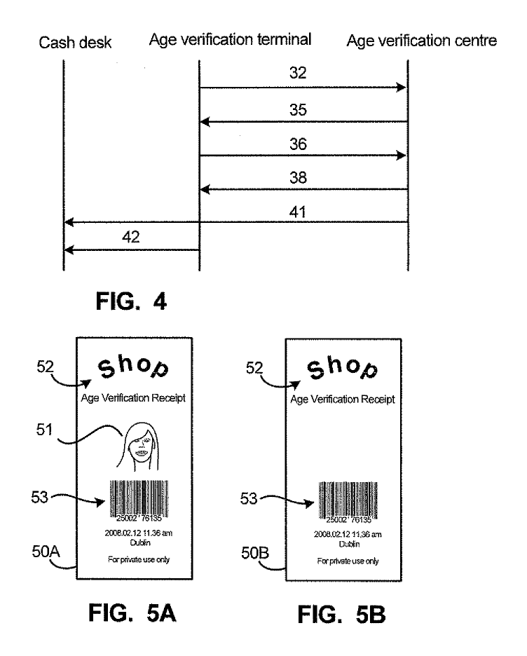

An embodiment of the operation of the system of FIG. 1 and the terminal 1A of FIGS. 2A and 2B will now be described with reference to FIG. 3 and FIG. 4. It will be assumed that a person, 22 years of age, enters the shop S and desires to purchase an age-restricted item. The age restriction for this item is 21. The person approaches the terminal 1A in order to have his age verified and to obtain a purchase ticket required for purchasing the age-restricted item. The display 12 informs the person of the age verification procedure.

The person may then, in step 30, first operate the confirmation module 19 using, for example, a key 13 in order to activate the video camera 10. The person may select or may have selected the age-restricted item using keys 13, although this is not necessary. The video camera 10 captures a live image of the person in step 31 and transmits the person image to the remote age verification center 2, using connection module 16 (step 32).

The controller 5 distributes the received person image to one of the available displays 6. A human operator estimates from the person image on the display 12 whether the purchaser has the required age for the selected item (step 33). The human operator is in doubt and believes that a further verification phase of the age is required (step 34). To that end, a request for an identification document is transmitted from the verification center 2 and received at the terminal 1A (step 35).

The display 12 instructs the person to provide an identification document. The document reader 11 is then activated. The person exposes an identification document to the document reader 11. An image of the identification document is transmitted from the terminal 1A to the verification center 2 in step 36. Moreover, video camera 10 can again capture another image of the person and also transmits this person image to the verification center 2 in step 36. It should be noted, however, that alternatively, the person image obtained in step 32 is used again. In the latter case, the person image is e.g. retrieved from the database 7 using an entry key assigned in step 32.

The controller 5 of the verification center 2 provides the image of the document to an available display 6 (which is not necessarily the same display 6 used for the first age verification phase) in combination with the person image (received in step 36 or obtained from database 7). The human operator is now able to conclude from the identification document image and the person image that the person is the legitimate holder of the identification document and that this person has reached the age of 22 and that, consequently, he is allowed to purchase the item (step 37). A purchase approval signal is then transmitted from the verification center 2 and is received at the terminal 1A in step 38. Controller 15 may now instruct ticket printer 14 to print a purchase ticket (step 39) as exemplified in FIGS. 5A and 5B.

The first age verification phase of step 33 will generally be sufficient in a majority of cases. If the person would e.g. have the age of 50, the first age verification phase would already have resulted in receiving the purchase approval signal at step 38. On the other hand, if the person would clearly be under-aged, the first age verification phase (step 33) would have resulted in denying the approval signal (step 40). The same would be true if the human operator would conclude that the age of the person was not sufficient in the second age verification phase (step 37). It should be noted, however, that denying of an approval signal does not necessarily imply that a purchase ticket will not be printed.

The age verification procedure may be accompanied by transmitting information to a cash desk system 4, as exemplified by the arrows 41/42 in FIG. 4. The information may be generated at the ticket code allocator 20 of terminal 1A and/or from the ticket code allocator 8 of the age verification center 2. The information comprises data regarding the printed purchase ticket. The information, which may be a ticket code, can be used at the cash desk system 4 to check whether the person passed the age verification procedure. The ticket code may also be provided from the verification center 2 to the cash desk system 4 via the terminal 1A.

Examples of purchase tickets 50A-50C are provided in FIGS. 5A and 5B.

In one advantageous embodiment, the purchase ticket 50A comprises a person image 51, a point-of-purchase indication 52 and a ticket code 53. It should be appreciated that the quality of the person image on the purchase ticket is not necessarily identical to that of the video image, but should be sufficient to recognize the legitimate holder of the purchase ticket. The person image 5S allows a cashier to directly link the purchase ticket to the person whose age has been verified.

In another embodiment, purchase ticket SOB does not comprise a person image, but only a point-of-purchase indication 52 and a ticket code 53. Such a purchase ticket would e.g. be sufficient for small shops, where there is no opportunity to hand over the purchase ticket to other people.

The purchase ticket may also be free of a ticket code and comprise a person image.

Once a person has obtained or otherwise secured a purchase ticket 50A, he may go to the cash desk system 4 for payment of the age-restricted item. He may then hand the purchase ticket 50A to the cashier, or otherwise indicate one has been secured. The cashier verifies from the person image 51 whether purchase ticket 50A belongs to the person and uses the ticket code 53 for the payment or completing the transaction. The ticket code 53 may e.g. be scanned in order to unlock the cash desk system 4 in order to allow payment for the item. Alternatively, the price of the item may be adapted from a high price to the correct price only after reading the ticket code 53 at the cash desk system 4.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. An age verification terminal configured for verifying the age of a person and providing a purchase ticket for purchasing an age-restricted item, the terminal comprising:
a video camera configured for capturing an image of said person;
a document reader configured for capturing an image of an identification document of said person;
connecting device configured for connecting to a remote age verification center wherein the connecting device is capable of transmitting information to the remote age verification center including images of the person and the identification document;
a receiver configured for receiving a purchase approval signal from said age verification center;
a controller configured for controlling a ticket printer to print said purchase ticket in response to receiving said purchase approval signal, said purchase ticket comprising at least one of said image of said person and a ticket code intended for allowing purchase of said age-restricted item
wherein said terminal is configured for:
transmitting said image of said person to said remote age verification center;
receiving said purchase approval signal when it has been determined from said image of said person alone that said person has an age allowing purchase of said age-restricted item;
receiving an identification request signal when said age of said person can not be determined from said image of said person, said identification signal representing a request for providing an identification document to said document reader;
transmitting said image of said identification document to said remote age verification center in response to receiving said identification request signal, and
receiving said approval signal when from said image of said identification document it can be determined that said person has an age allowing purchase of said age-restricted item.

2. The terminal according to claim 1, wherein said controller is further configured for controlling said ticket printer to print a point-of-purchase indication on said purchase ticket.

3. The terminal according to claim 1, wherein said controller is further configured for controlling said ticket printer to print information associated with one or more age-restricted items on said ticket.

4. The terminal according to claim 1, and further comprising one or more item selectors configured for selecting one or more age-restricted items.

5. The terminal according to claim 1, and further comprising a display module for providing information to said person.

6. The terminal according to claim 1, wherein said document reader comprises a further video camera.

7. The terminal according to claim 1, and further comprising a confirmation module configured for instructing said video camera to capture said image.

8. The terminal according to claim 1, and further comprising a ticket code allocator configured for allocating said ticket code to said purchase ticket, said controller being configured for controlling said ticket printer to print said ticket code on said purchase ticket and a communication module configured for connecting to a cash desk system and communicating said ticket code to said cash desk system.

9. A computer-implemented method of verifying the age of a person and providing a purchase ticket for said person to purchase an age-restricted item, comprising:
capturing an image of said person;
transmitting said image of said person to a remote age verification center;
receiving a purchase approval signal from said age verification center when it has been determined from said image of said person alone that said person has an age allowing purchase of said age-restricted item
receiving an identification request signal when said age of said person can not be determined from said image of said person alone, said identification signal representing a request for providing an image of an identification document;
transmitting said image of said identification document to said remote age verification center in response to receiving said identification request signal, and
receiving said purchase approval signal when from said image of said identification document it can be determined that said person has an age allowing purchase of said age-restricted item; and
printing said purchase ticket in response to said purchase approval signal, said purchase ticket comprising at least one of said image of said person and a ticket code intended for allowing purchase of said age-restricted item.

10. (canceled)

11. (canceled)

12. The method according to claim 9, and further comprising printing a point-of-purchase indication on said purchase ticket.

13. The method according to claim 9, and further comprising printing information associated with one or more age-restricted items on said ticket.

14. The method according to claim 9, and further comprising selecting one or more age-restricted items.

15. The method according to claim 9, and further comprising displaying age verification information to said person.

16. The method according to claim 9, and further comprising capturing said image of said identification document of said person with a further video camera.

17. The method according to claim 9, and further comprising receiving confirmation information for instructing said video camera to capture said image.

18. The method according to claim 9, and further comprising:
printing said ticket code on said purchase ticket;
communicating said ticket code to a cash desk system.

19. An age verification and purchase system configured for verifying the age of a person and providing a purchase ticket for purchasing an age-restricted item, the system comprising the age verification terminal according to claim 1 and an age verification center.

20. The system according to claim 19, wherein said age verification center comprises one or more display units and said purchase approval signal is provided to said receiver after human verification of at least one of said image of said person and said image of said identification document on said one or more display units.

21. An age verification center for use in the system of claim 19, wherein the center comprises a connection module configured for connecting to a plurality of age verification terminals over a network.

22. The age verification center according to claim 21 wherein said age verification center comprises a plurality of display units and a controller configured for distributing incoming images of persons and/or identification documents of said persons amongst said display units.

23. The age verification center according to claim 22, wherein said controller is configured to manage a waiting cue of images to be verified.

24. The age verification center according to claim 22, wherein said controller is configured for providing said image of said person to a first display unit and said image of said identification document in combination with an image of said person to a second display unit, different from said first display unit.

25. The age verification center according to claim 22, wherein said controller is configured to release a display unit after displaying an image of a person captured by a first age verification terminal and to display on said display unit an image of a person captured by a second age verification terminal.

26. The age verification center according to claim 21, wherein said center further comprises a ticket code allocator for allocating said ticket code for said purchase ticket and a communication module for communicating said ticket code to at least one of an age verification terminal and a cash desk system.

27. The terminal according to claim 1 and further comprising:
a printer; and
a purchase ticket generated by the printer, the purchase ticket comprising an image of a person to which the ticket was issued and a ticket code intended for allowing purchase of said age-restricted item.

28. An age verification terminal configured for verifying the age of a person and providing a purchase authorization for purchasing an age-restricted item, the terminal comprising:
at least one image capture device configured for capturing an image of said person and an image of an identification document of said person;
a connecting device configured for connecting to a remote age verification center to transmit said image of said person and said image of said identification document to said age verification center and to transmit an identification request signal and receive a purchase approval signal;
a controller configured for rendering the purchase authorization in response to receiving said purchase approval signal, said purchase authorization comprising at least one of said image of said person and a ticket code intended for allowing purchase of said age-restricted item;
wherein said terminal is further configured for:
transmitting said image of said person to said remote age verification center;
receiving said purchase approval signal when it has been determined from said image of said person alone that said person has an age allowing purchase of said age-restricted item;
receiving an identification request signal when said age of said person can not be determined from said image of said person, said identification signal representing a request for providing an identification document to said document reader;
transmitting said image of said identification document to said remote age verification center in response to receiving said identification request signal, and
receiving said approval signal when from said image of said identification document it can be determined that said person has an age allowing purchase of said age-restricted item.

29. A method of verifying the age of a person and providing a purchase ticket for said person to purchase an age-restricted item, comprising:
providing an age verification terminal proximate a shop that sells age-restricted items;
utilizing the terminal to capture an image of said person;
transmitting said image of said person from the terminal to a remote age verification center;
analyzing the image at the remote age verification center to determine whether the person is of the age required to purchase the age-restricted item;
receiving a purchase approval signal at the terminal from said age verification center when it has been determined from said image of said person alone that said person is of an age allowing purchase of said age-restricted item; and
utilizing the terminal to print a purchase ticket in response to said purchase approval signal, said purchase ticket comprising at least one of said image of said person and a ticket code intended for allowing purchase of said age-restricted item.

30. The method of claim 29 and further comprising:
receiving an identification request signal at the terminal prior to receiving the purchase approval signal when said age of said person can not be determined from said image of said person alone, said identification signal representing a request for providing an image of an identification document;
utilizing the terminal to convey a request to provide an identification document to the person;
transmitting said image of said identification document to said remote age verification center in response to receiving said identification request signal, and
receiving said purchase approval signal from the age verification center when said identification document it can be determined that said person has an age allowing purchase of said age-restricted item.
